(19) United States
(12) Patent Application Publication
(10) Pub. No.: US 2026/0307699 A1
(43) Pub. Date: Oct. 8, 2026

(54) WHEELED PLATFORM WITH LINKED LATCHES FOR ENGAGING A WALL-PROVIDING ACCESSORY

(71) Applicant: LOADHOG LIMITED, Sheffield, South Yorkshire (GB)

(72) Inventors: LUKE DAVIS, Sheffield, South Yorkshire (GB); ADAM GIBBONS, Sheffield, South Yorkshire (GB)

(21) Appl. No.: 19/476,993

(22) PCT Filed: Apr. 16, 2024
(86) PCT No.: PCT/IB2024/053698

§ 371 Date: Oct. 20, 2025

(30) Foreign Application Priority Data
Apr. 21, 2023 (GB) 2305872.0
Apr. 15, 2024 (GB) 2405305.0

(51) Int. Cl. B62B 3/02

(52) U.S. Cl. CPC B62B 3/02

(57) ABSTRACT

Manual handling equipment 100 to which a wall-providing accessory 200 is mountable, wherein the manual handling equipment 100 comprises a body 102 and a set of locking connectors 118 spaced towards opposite ends of a side 122, 126 of the body 102, wherein the set of locking connectors 118 are connected to one or more user inputs 116, wherein movement of one of the one or more user inputs 116 actuates the set of locking connectors 118 simultaneously to engage or disengage the set of locking connectors 118 with the wall-providing accessory 200.

### FIELD OF THE INVENTION

Embodiments of the present invention relate to a wheeled platform with linked latches for engaging a wall-providing accessory, and to a system comprising the wheeled platform and the wall-providing accessory. In particular, but not exclusively, the wheeled platform is a dolly.

### BACKGROUND TO THE INVENTION

Manual handling equipment describes a class of material transport equipment onto which goods can be loaded, and which can be moved by hand to transport the goods. An example of manual handling equipment is a type of wheeled platform called a dolly. A dolly is a wheeled platform onto which goods can be loaded.

### BRIEF DESCRIPTION OF VARIOUS EMBODIMENTS OF THE INVENTION

According to various, but not necessarily all, embodiments of the invention there is provided wheeled manual handling equipment to which a wall-providing accessory is mountable, wherein the wheeled manual handling equipment comprises a body and a plurality of latches to lock the wall-providing accessory to the wheeled manual handling equipment, wherein each latch comprises a user input and a locking connector, wherein movement of the user input actuates the locking connector to engage or disengage the locking connector with the wall-providing accessory, wherein the plurality of latches comprises a first set of latches coupled to each other by a first linkage, enabling movement of the user input of a first one of the first set of latches to actuate the locking connectors of each of the first set of latches.

The first linkage provides the advantage that the user only needs to move one user input to actuate two spaced locking connectors. This minimises the required number of user actions to lock or release the wall-providing accessory, without reducing the number of latches. Therefore, the wall-providing accessory can be easily and securely locked to and unlocked from the manual handling equipment.

According to various, but not necessarily all, embodiments of the invention there is provided manual handling equipment to which a wall-providing accessory is mountable, wherein the manual handling equipment comprises a body and a set of locking connectors spaced towards opposite ends of a side of the body, wherein the set of locking connectors are connected to one or more user inputs, wherein movement of one of the one or more user inputs actuates the set of locking connectors simultaneously to engage or disengage the set of locking connectors with the wall-providing accessory.

The first linkage may further enable movement of the user input of a second one of the first set of latches to actuate the locking connectors of the both of the first set of latches. An advantage is that any arbitrary one of the user inputs can actuate each locking connector.

The first set of latches may be a first pair of latches. The first pair of latches may be spaced along a first common side of the manual handling equipment. The first pair of latches may be spaced towards opposite ends of the manual handling equipment.

The first pair of latches may be proximal to opposite corners of the first common side.

The first linkage may comprise a rotatable shaft to lock rotation of the first pair of latches.

The first linkage may connect bearings of the first pair of latches to each other.

The plurality of latches may further comprise a second set of latches opposite the first set of latches, coupled to each other by a second linkage.

The second set of latches may be spaced along a second common side of the manual handling equipment. The second set of latches may be spaced towards opposite ends of the manual handling equipment.

The second set of latches may be a second pair of latches. The second pair of latches may be proximal to opposite corners of the second common side.

The second set of latches and the second linkage may work in the same manner as the first set of latches.

An advantage is that the user only needs to move two user inputs to actuate four spaced locking connectors.

The user input may be in the form of a pedal. The pedal may be a foot pedal. The foot pedal may comprise a foot cavity. A foot pedal is advantageous as users do not need to stoop. A foot cavity is advantageous because the user input can be moved in opposite directions by raising or lowering the foot.

The locking connector may be in the form of a plug. The plug may be in the form of a tooth.

The wall-providing accessory may comprise apertures into which the locking connectors of the plurality of latches can fit.

The plurality of latches may be pivotably connected to the body of the manual handling equipment.

The plurality of latches may be configured for depress-to-release operation.

Referring to each latch, movement of the user input in a first direction may actuate the locking connector in a first direction to an engaging position of the latch to engage the locking connector with the wall-providing accessory.

Movement of the user input in a second opposite direction may actuate the locking connector in a second opposite direction to a disengaging position of the latch to disengage the locking connector from the wall-providing accessory. Referring to each latch, the manual handling equipment may comprise an over-centre mechanism to lock the latch in the engaging position and to lock the latch in the disengaging position.

An advantage of the over-centre mechanism is that there is resistance to accidental latch actuation, and tactile feedback to indicate that the latch has been moved between its engaging position and disengaging position.

The body of the manual handling equipment may comprise a channel into which the wall-providing accessory is mountable. The plurality of latches may be configured to lock the wall-providing accessory within the channel. The channel may function as a socket. An advantage of the channel is that the wall-providing accessory is held even more securely, and the channel sets a depth to engage the locking connector.

The channel may be a floor channel. The floor channel may comprise a floor recess extending continuously or discontinuously along the periphery of the manual handling equipment. The floor recess may extend parallel to the manual handling equipment's perimeter.

The user input may be positioned below the locking connector. Where the user input may comprise a foot cavity, the foot cavity may be positioned below a base of the channel. An advantage is that the foot cavity can be deep enough in the horizontal direction to enable a user to embed their shoe in the foot cavity, without the foot cavity interfering with the channel.

The wall-providing accessory may comprise a plurality of wall panels lowerable into the channel, and configured to extend continuously or discontinuously along the periphery of the manual handling equipment when the wall-providing accessory is mounted to the manual handling equipment. The channel may be inboard of the manual handling equipment's perimeter and parallel to the perimeter. Lower edges of the wall panels may be lowerable into the channel. The locking connector may be movable into and out of the channel. The locking connector may be pivotably movable in a horizontal direction into and out of the channel. The wall-providing accessory may be vertically movable into and out of the channel when not locked by the plurality of latches.

The body of the manual handling equipment may comprise a floor onto which articles can be placed. The channel may be formed in the periphery of the floor. The body of the manual handling equipment may comprise a moulding defining a single part such as a plastics part. The part may comprise the floor, and at its underside may comprise wheel assembly mounts.

The body may comprise side walls defining the manual handling equipment's perimeter. The latches may be recessed into the side walls. The user inputs may be recessed into the side walls.

The side walls may be mostly or entirely below floor level. The side walls may provide a raised lip around the floor.

The side walls may define an outboard edge of the channel. The raised lip may define the outboard edge of the channel. An advantage is further stabilisation of the wall-providing accessory.

The locking connectors may protrude into the channel through apertures in the side walls.

The manual handling equipment may be four-sided. The manual handling equipment may comprise long sides and short sides. The plurality of latches may be located along the long sides. The first set of latches may be spaced along a first of the long sides. The second set of latches may be spaced along a second of the long sides.

The manual handling equipment may be wheeled manual handling equipment. The wheeled manual handling equipment may be four-wheeled. The wheeled manual handling equipment may be a wheeled platform. The wheeled platform may be a dolly, also known as a flatbed trolley. The wheeled manual handling equipment may comprise caster wheels (castor wheels).

According to various, but not necessarily all, embodiments of the invention there is provided a system comprising the manual handling equipment and the wall-providing accessory. Mounting of the wall-providing accessory to the manual handling equipment may transform the system from a flatbed to a box.

The wall-providing accessory may be in the form of a sleeve. Therefore, the wall-providing accessory may be open-topped and open-bottomed. The sleeve may be foldable into a shape conforming to a shape of the channel of the manual handling equipment. The wall-providing accessory may be alternatively referred to as a wall accessory or a sleeve.

### BRIEF DESCRIPTION OF THE DRAWINGS

For a better understanding of various examples of embodiments of the present invention reference will now be made by way of example only to the accompanying drawings in which:

FIG. 1 illustrates a wheeled manual handling equipment;

FIG. 2 illustrates a system comprising the wheeled manual handling equipment and a wall-providing accessory;

FIG. 3 illustrates a pair of latches connected by a linkage;

FIG. 4 illustrates a cross-section showing a latch in an engaging position; and

FIG. 5 illustrates a cross-section showing a latch in a disengaging position.

### DETAILED DESCRIPTION OF VARIOUS EMBODIMENTS OF THE INVENTION

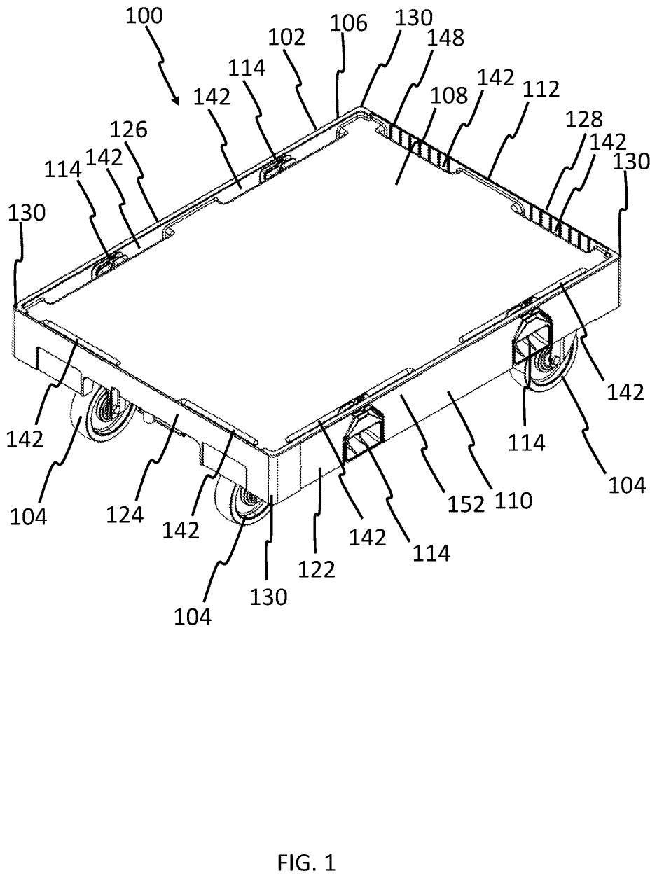

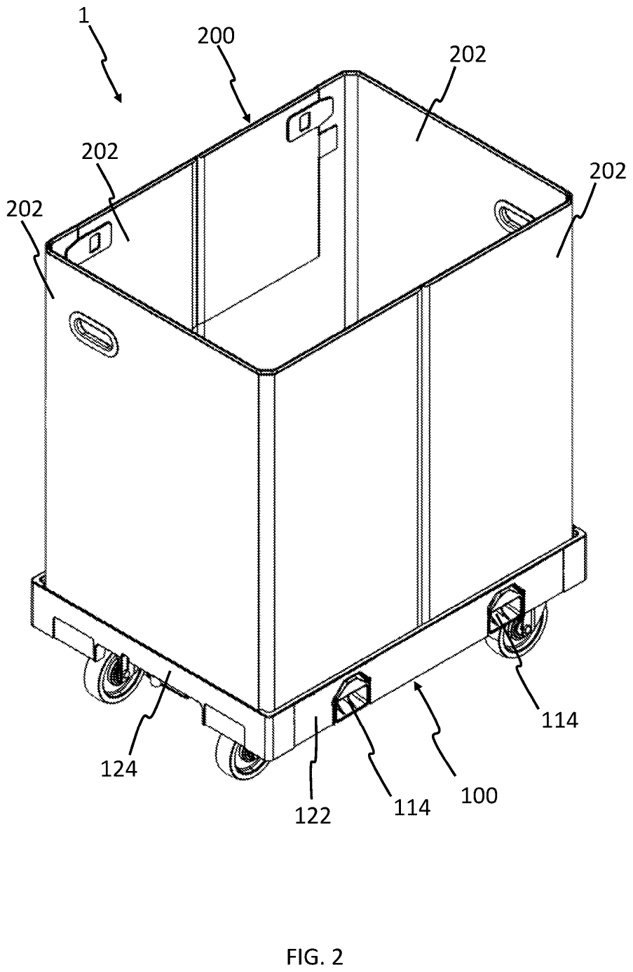

FIG. 1 illustrates a general arrangement of wheeled manual handling equipment in the form of a dolly 100. However, in other implementations, the wheeled manual handling equipment could be a different type of manual handling equipment. FIG. 2 illustrates a wall-providing accessory 200 mounted to the dolly 100 to form a system 1.

The dolly 100 comprises a body 102 and a plurality of wheels 104 beneath the body 102. The body 102 in is a wheeled platform 106 for supporting a load.

The illustrated dolly 100 is four-sided. The dolly 100 comprises a pair of long sides 122, 126 connected at the ends of the dolly 100 to a pair of short sides 124, 128 via corners 130. The illustrated dolly 100 has a generally rectangular shape.

The illustrated body 102 comprises a main moulded plastics part 152. The main part 152 comprises a substantially flat or ribbed floor 108 defining a floor level onto which articles can be placed. The main part 152 further comprises side walls 110 surrounding the floor 108. The side walls 110 define the perimeter 148 of the dolly 100. The side walls 110 are mostly below the floor level, but their top edges protrude slightly above the floor level to provide a raised lip 112. The raised lip 112 prevents load spillage.

The height of the dolly 100 above ground level (bottom of wheels 104) may be less than 30 centimetres. Therefore, the dolly 100 provides a flatbed for transporting articles.

The wheels 104 may be casters. A wheel may be provided proximal to each corner 130 of the dolly 100. The wheels 104 are arranged in two pairs: a first pair of wheels at one end of the body 102, and a second pair of wheels at the opposite end of the body 102. The wheels 104 may be mounted to the underside of the main part 152 of the dolly 100. The main part 152 may be moulded with wheel assembly mounts (not shown) for the wheels 104.

FIG. 1 shows the body 102 of the dolly 100 comprising a channel in the form of a floor recess 142, which is a depression in the floor 108 into which the wall-providing accessory 200 of FIG. 2 can be lowered. The illustrated floor recess 142 is formed in the floor 108 and is inboard of the side walls 110 of the dolly 100.

In other examples, the channel is provided outboard of the side walls 110 of the dolly 100.

Further, although the Figures illustrate the dolly 100 having the channel, in other examples the wall-providing accessory 200 may have the channel and the dolly 100 may comprise a protrusion onto which the channel can be lowered.

The illustrated floor recess 142 is an elongate recess extending along the periphery of the floor 108 of the dolly 100. The floor recess 142 extends discontinuously around a plurality of sides, in this example the four sides of the dolly 100. This results in a four-sided floor recess 142. Where the floor recess 142 extends discontinuously, this provides discontinuities where the floor 108 attaches to the side walls 110 at floor-level.

In the illustrated example, the floor recess 142 is peripheral in the sense that the outboard edge of the floor recess 142 is defined by the perimeter 148 of the dolly 100. It can be said that the floor recess 142 extends parallel to the perimeter 148 of the dolly 100. Where the perimeter 148 may be defined by raised lip 112, it can be said that the outboard edge of the floor recess 142 is defined by the side walls 110, or more specifically by the raised lip 112 of the side walls 110.

The body 102 may comprise side walls 110 extending around a perimeter 148 of the dolly 100.

To lock the wall-providing accessory 200 within the floor recess 142, the dolly 100 further comprises a plurality of latches 114. FIG. 1 shows four latches 114 including a first pair of latches 114 spaced along the long side 122 of the dolly 100, and a second pair of latches 114 spaced along the opposite long side 126 of the dolly 100. The latches 114 of each pair are spaced towards opposite corners 130 of the corresponding edge.

The illustrated latches 114 are recessed into the side walls 110, and parts of the latches 114 are movable to protrude into the floor recess 142 to lock the wall-providing accessory 200 within the floor recess 142.

FIG. 2 illustrates the wall-providing accessory 200 mountable to the dolly 100. In this example the wall-providing accessory 200 is in the form of a sleeve which is open-topped and open-bottomed.

The wall-providing accessory 200 comprises a plurality of wall panels 202 connected to each other by living hinges, foldable into a shape that can be lowered into the floor recess 142.

The wall panels 202 of the wall-providing accessory 200 are at least tens of centimetres in height, to transform the system 1 from a wheeled flatbed as shown in FIG. 1 to a wheeled box as shown in FIG. 2.

Where the dolly 100 may be four-sided, the wall-providing accessory 200 may have four wall panels 202, each corresponding to one of the sides. Where the dolly 100 may be rectangular, the wall panels 202 include long wall panels 202 and short wall panels 202 foldable into a rectangular shape to fit within the corresponding rectangular floor recess 142.

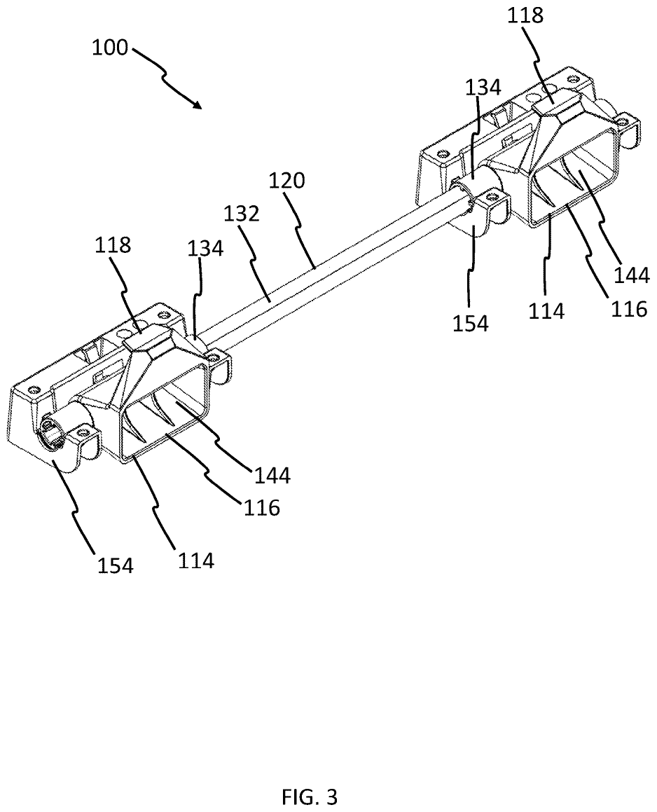

FIGS. 3-5 illustrate the latches 114 in more detail. Each latch 114 comprises a user input in the form of a foot pedal 116, and a locking connector 118 in the form of a tooth or other suitable plug. The foot pedal 116 and the locking connector 118 are connected to each other as a single part. As shown in FIG. 3, each part comprises bearings 134 which are pivotably connected to a bearing assembly 154 of the body 102 of the dolly 100.

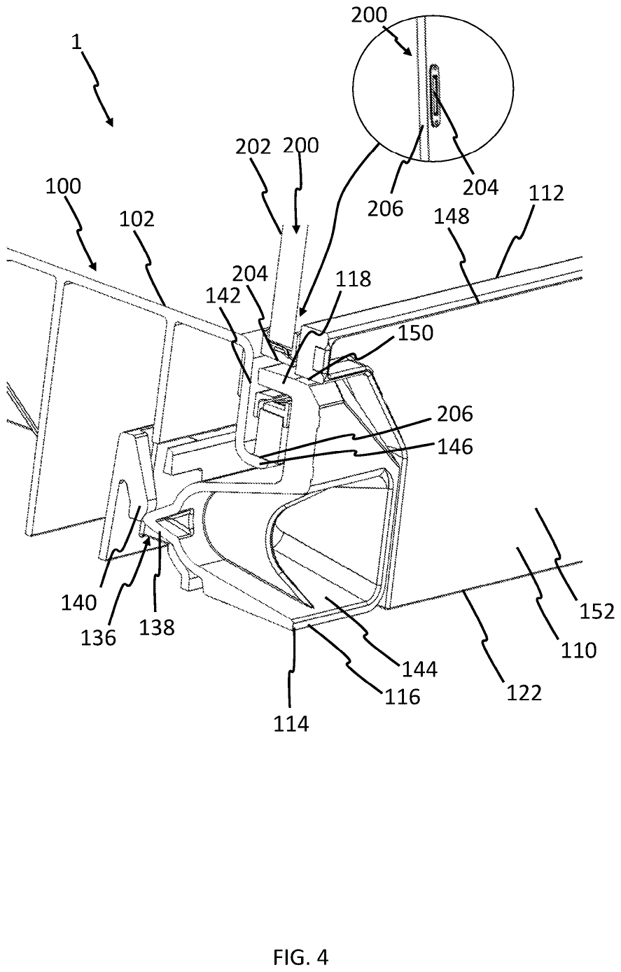

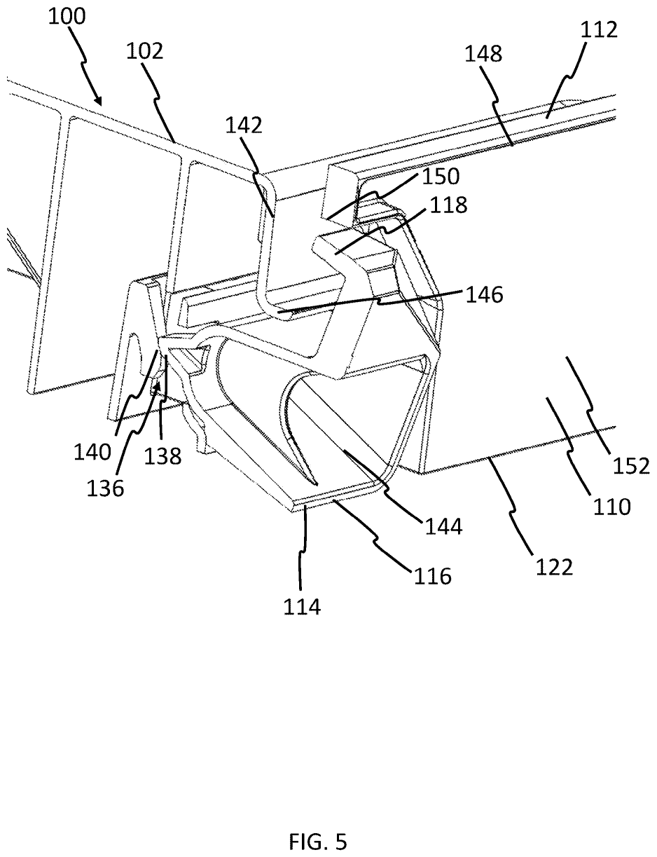

As shown in FIGS. 4-5, as a latch 114 is rotated via input force provided at the foot pedal 116, the locking connector 118 rotates horizontally towards or away from the floor recess 142 via an aperture 150 in a side wall 110 of the dolly 100. The foot pedal 116 may be bidirectionally rotatable to move the locking connector 118 towards and away from the floor recess 142.

As shown in FIG. 4, particularly the detail view, the wall-providing accessory 200 has apertures 204 proximal to its lower edges 206. When the lower edges 206 of the wall panels 202 of the wall-providing accessory 200 are lowered into the floor recess 142, the apertures 204 of the wall-providing accessory 200 align with the apertures 150 in a side wall 100 of the dolly 100, or more specifically with the locking connectors 118 of the latches 114.

Each latch 114 can be rotated via input force provided at the foot pedal 116, from a disengaging position shown in FIG. 5 to an engaging position shown in FIG. 4. This causes the locking connector 118 to rotate into (or further into) the floor recess 142 to engage the locking connector 118 with the aligned aperture of the wall-providing accessory 200, in an interference fit. When all latches 114 are in the engaging position, the wall-providing accessory 200 is securely locked in position so that it cannot be lifted out of the dolly 100.

To release the wall-providing accessory 200, the latch 114 is rotated in the opposite direction via opposite input force provided at the foot pedal 116, from the engaging position shown in FIG. 4 to the disengaging position shown in FIG. 5. Once all latches 114 have been released, the wall-providing accessory 200 can be lifted out of the floor recess 142.

A foot pedal 116 is convenient because the user will not have to stoop down. The foot pedal 116 comprises a surface sized to receive a sole of a shoe. Some users may be able to use their hands if they prefer. In other implementations, a smaller finger input is used instead of a foot pedal 116.

The illustrated foot pedal 116 is in the form of a foot cavity 144, into which part of a forefoot can be horizontally inserted. The foot cavity 144 is a recess having lower and upper boundaries. A foot cavity 144 means that downwards force from the sole of a shoe against the lower boundary rotates the foot pedal 116 in a depressing direction, while upwards force from the toe box of the shoe against the upper boundary rotates the foot pedal 116 in an opposite upwards direction. The depression direction may rotate the latch 114 from the engaging position to the disengaging position. The upwards direction may rotate the latch 114 from the disengaging position to the engaging position. In another example, the latches 114 are modified such that upwards motion engages the latch 114 and downwards motion disengages the latch 114.

Due to the substantial horizontal depth of the foot pedal 116, FIGS. 4-5 show that the foot pedal 116 is positioned below the base 146 of the floor recess 142. This provides a suitable compromise between the vertical depth of the floor recess 142 (for stability) and the horizontal depth of the foot pedal 116 (for foot purchase). In other examples, a different type of user input may be used such that a deeper floor recess 142 can be implemented.

Although FIGS. 3-5 illustrate the locking connector 118 being a tooth which is a type of plug, and the aperture in the wall-providing accessory 200 is a socket for the tooth. In other examples, the locking connector 118 comprises a socket and the wall-providing accessory 200 comprises a plug.

The latches 114 may stay in the engaging and disengaging positions when no input force is applied. To facilitate this, FIGS. 4-5 illustrate an over-centre mechanism 136 to resist movement of the latch 114 between the engaging and disengaging positions. The resistance can be overcome by the user but is calibrated to prevent unintentional movement of the latches 114.

The over-centre mechanism 136 is formed by the combination of a pivoting member 138 and a reactor 140 in the form of a cantilevered protrusion. In the illustrated example, the pivoting member 138 is part of the latch 114. The reactor 140 is a static part of the body 102 of the dolly 100, and provides a lobe surface against which the pivoting member 138 can slide during pivoting of the latch 114. As the latch 114 is pivoted, the pivoting member 138 slides along the lobe surface while resiliently deflecting the reactor 140 in the manner of a spring, until the latch 114 slides past an over-centre position of the lobe surface. The over-centre position defines the maximum resistance force of the reactor 140. In other examples, a different type of over-centre mechanism 136 can be used, or no over-centre mechanism.

FIG. 3 illustrates that each pair of latches 114 is coupled to each other by a linkage 120. The linkage 120 enables movement of the foot pedal 116 of any arbitrary one of the pair of latches 114 to actuate the locking connectors 118 of both of the pair of latches 114 simultaneously in the same direction.

Therefore, although the dolly 100 of FIG. 1 has four latches 114 spaced far apart from each other, only two user actions are required to actuate four locking connectors 118 to the engaging position. Likewise, only two user actions are required to actuate four locking connectors 118 to the disengaging position.

The linkage 120 comprises a rotatable shaft 132. The length of the linkage 120 depends on how far apart the latches 114 are spaced. In this case, as the latches 114 are proximal to opposite corners 130 of the corresponding side of the dolly 100, the linkage 120 is elongate having a length in the order of tens of centimetres. The linkage 120 may be formed from a metal material to resist torsional twisting.

Where each latch 114 comprises a pair of bearings 134 rotatably mounted to the bearing assembly 154 of the body 102 of the dolly 100, the bearings 134 of the pair of latches 114 which face each other may each comprise a plug-socket connection to the linkage 120. The bearings 134 may comprise sockets to receive the ends of the linkage 120. The linkage 120 may be non-axisymmetric (noncircular) to resist slippage within the sockets. The linkage 120 may be press-fit (interference fit) within the sockets, deforming inner material of the sockets to provide a secure connection.

Although embodiments of the present invention have been described in the preceding paragraphs with reference to various examples, it should be appreciated that modifications to the examples given can be made without departing from the scope of the invention as claimed. For example, a single user input 116 may be connected to the locking connectors 118 on both sides of the dolly 100, to further reduce the number of inputs required. A user input 116 may be connected to one or each of the short sides 124, 128. The or each user input 116 may be connected laterally to both linked pairs of locking connectors 118.

Further, the manual handling equipment is not limited to being a dolly and could instead be a pallet, without wheels.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Manual handling equipment to which a wall-providing accessory is mountable, wherein the manual handling equipment comprises a body and a set of locking connectors spaced towards opposite ends of a side of the body, wherein the set of locking connectors are connected to one or more user inputs, wherein movement of one of the one or more user inputs actuates the set of locking connectors simultaneously to engage or disengage the set of locking connectors with the wall-providing accessory.

2. The manual handling equipment of claim 1, wherein the manual handling equipment comprises a plurality of latches to lock the wall-providing accessory to the wheeled manual handling equipment,
wherein each latch comprises one of the user inputs and one of the set of locking connectors,
wherein movement of the user input actuates the locking connector to engage or disengage the locking connector with the wall-providing accessory, and
wherein the plurality of latches comprises a first set of latches coupled to each other by a first linkage, enabling movement of the user input of a first one of the first set of latches to actuate the locking connectors of each of the first set of latches.

3. The manual handling equipment of claim 2, wherein the first linkage further enables movement of the user input of a second one of the first set of latches to actuate the locking connectors of the both of the first set of latches.

4. The manual handling equipment of claim 2, wherein the first set of latches is a first pair of latches, and wherein the first pair of latches are spaced along a first common side of the wheeled manual handling equipment.

5. The manual handling equipment of claim 4, wherein the first linkage comprises a rotatable shaft to lock rotation of the first pair of latches.

6. The manual handling equipment of claim 5, wherein the first linkage connects bearings of the first pair of latches to each other.

7. The manual handling equipment of claim 2, wherein the plurality of latches further comprises a second set of latches opposite the first set of latches, coupled to each other by a second linkage, enabling movement of the user input of a first one of the second set of latches to actuate the locking connectors of each of the second set of latches.

8. The manual handling equipment of claim 2, wherein the user input is in the form of a pedal, and wherein the pedal is a foot pedal.

9. The manual handling equipment of claim 2, wherein the plurality of latches are pivotably connected to the body of the wheeled manual handling equipment.

10. The manual handling equipment of claim 2, wherein for each latch, movement of the user input in a first direction actuates the locking connector in a first direction to an engaging position of the latch to engage the locking connector with the wall-providing accessory, and wherein movement of the user input in a second opposite direction actuates the locking connector in a second opposite direction to a disengaging position of the latch to disengage the locking connector from the wall-providing accessory.

11. The manual handling equipment of claim 10, wherein for each latch, the wheeled manual handling equipment comprises an over-centre mechanism to lock the latch in the engaging position and to lock the latch in the disengaging position.

12. The manual handling equipment of claim 2, wherein the body of the wheeled manual handling equipment comprises a channel into which the wall-providing accessory is mountable, and wherein the plurality of latches are configured to lock the wall-providing accessory within the channel.

13. (canceled)

14. (canceled)

15. The manual handling equipment of claim 12, wherein the locking connector is movable into and out of the channel, wherein the locking connector is pivotably movable in a horizontal direction into and out of the channel, and wherein the wall-providing accessory is vertically movable into and out of the channel when not locked by the plurality of latches.

16. The manual handling equipment of 12, wherein the body of the wheeled manual handling equipment comprises a floor onto which articles can be placed, and wherein the channel is formed in the periphery of the floor.

17. (canceled)

18. The manual handling equipment of claim 2, wherein the body comprises side walls defining the wheeled manual handling equipment's perimeter, and wherein the user inputs are recessed into the side walls.

19. (canceled)

20. (canceled)

21. A system comprising the manual handling equipment as claimed claim 1, and the wall-providing accessory.

22. The system of claim 21, wherein mounting of the wall-providing accessory to the manual handling equipment transforms the system from a flatbed to a box.

23. The system of claim 21, wherein the wall-providing accessory is in the form of a sleeve, and wherein the wall-providing accessory is open-topped and open-bottomed.

24. (canceled)

25. The system of 21, wherein, the manual handling equipment comprises a plurality of latches to lock the wall-providing accessory to the manual handling equipment,
wherein each latch comprises one of the user inputs and one of the set of locking connectors, wherein movement of the user input actuates the locking connector to engage or disengage the locking connector with the wall-providing accessory, and
wherein the plurality of latches comprises a first set of latches coupled to each other by a first linkage, enabling movement of the user input of a first one of the first set of latches to actuate the locking connectors of each of the first set of latches,
wherein the body of the manual handling equipment comprises a channel into which the wall-providing accessory is mountable, wherein the plurality of latches are configured to lock the wall-providing accessory within the channel-wherein the wall-providing accessory comprises a plurality of wall panels lowerable into the channel, and configured to extend continuously or discontinuously along the periphery of the wheeled manual handling equipment when the wall-providing accessory is mounted to the wheeled manual handling equipment.

26. The manual handling equipment of claim 1, wherein the manual handling equipment is wheeled manual handling equipment to which the wall-providing accessory is mountable, wherein the wheeled manual handling equipment comprises the body.
